(19) United States
(12) Patent Application Publication
(10) Pub. No.: US 2026/0319329 A1
(43) Pub. Date: Oct. 15, 2026

(54) REFLECTION MODULE AND CAMERA MODULE INCLUDING THE SAME

(71) Applicant: SAMSUNG ELECTRO-MECHANICS CO., LTD., Suwon-si (KR)

(72) Inventors: Yun Gu LEE, Suwon-si (KR); Po Chul KIM, Suwon-si (KR)

(73) Assignee: SAMSUNG ELECTRO-MECHANICS CO., LTD., Suwon-si (KR)

(21) Appl. No.: 19/562,985

(22) Filed: Mar. 11, 2026

(30) Foreign Application Priority Data
Apr. 15, 2025 (KR) 10-2025-0049131
Nov. 7, 2025 (KR) 10-2025-0167512

(51) Int. Cl. G03B 5/00

(52) U.S. Cl. CPC G03B 5/00; G03B 2205/0007; G03B 2205/0069

(57) ABSTRACT

A reflection module includes a housing; a guide member, disposed in the housing and configured to rotate, relatively with respect to the housing about a first axis; a reflection holder disposed on the guide member and configured to rotate relatively with respect to the guide member about a second axis; a reflection member disposed on the reflection holder; and a driver providing rotational force to rotate the guide member and the reflection holder. The driver includes a plurality of driving magnets spaced apart from each other in a direction of the first axis; and a plurality of driving coils which face each of the plurality of driving magnets in a direction of the second axis, and the plurality of driving magnets are disposed on one surface of the reflection holder or the housing, and the driver is spaced apart from a center of the one surface.

### CROSS-REFERENCE TO RELATED APPLICATIONS

This application claims the benefit under 35 USC §119(a) of Korean Patent Application No. 10-2025-0049131 filed on Apr. 15, 2025, and Korean Patent Application No. 10-2025-0167512 filed on Nov. 7, 2025, in the Korean Intellectual Property Office, the entire disclosures of which are incorporated herein by reference for all purposes.

### BACKGROUND

### 1. Field

The following description relates to a reflection module and a camera module including the same.

### 2. Description of Related Art

Camera modules, in which a reflection module is disposed in front of a lens module to change an optical path, have been implemented in mobile devices.

Furthermore, a camera module may have an optical image stabilization (OIS) operation to compensate for camera shake during the capture of an image to improve resolution. Such an optical image stabilization operation is achieved through a dual axis rotation of the reflection module.

In this example, a plurality of drivers may be desired for the dual axis rotation of the reflection module. However, implementing the plurality of drivers may result in a complex structure and increased overall weight of the camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a reflection module includes a housing; a guide member, disposed in the housing and configured to rotate, relatively with respect to the housing about a first axis; a reflection holder, disposed on the guide member, and configured to rotate relatively with respect to the guide member about a second axis; a reflection member disposed on the reflection holder; and a driver which provides a rotational force to rotate the guide member and the reflection holder, wherein the driver includes a plurality of driving magnets spaced apart from each other in a direction of the first axis; and a plurality of driving coils disposed to face each of the plurality of driving magnets in a direction of the second axis, wherein the plurality of driving magnets are disposed on one surface of the reflection holder or the housing, and wherein the driver is spaced apart from a center of the one surface.

The driver may be spaced apart from the second axis in the direction of the first axis, and the driver may be spaced apart from the first axis in the direction of the second axis.

Each of the plurality of driving magnets may be spaced apart from the first axis by a same distance.

The plurality of driving magnets may be disposed symmetrically with respect to the center of the one surface.

Each of the plurality of driving magnets may be spaced apart from the center of the one surface by a same distance.

A first ball member including a plurality of balls is disposed between the guide member and the housing, wherein the plurality of balls of the first ball member are spaced apart from each other in the direction of the first axis.

A second ball member including a plurality of balls may be disposed between the guide member and the reflection holder, and the plurality of balls of the second ball member may be spaced apart from each other in the direction of the second axis.

A virtual line connecting the plurality of balls of the first ball member in the direction of the first axis may be spaced apart from the plurality of driving magnets in the direction of the second axis, and a virtual line connecting the plurality of balls of the second ball member in the direction of the second axis may be spaced apart from the plurality of driving magnets in the direction of the first axis.

A plurality of first sensing magnets spaced apart from each other in the direction of the first axis may be further included in the reflection holder.

The reflection module may further include a second sensing magnet disposed between the plurality of driving magnets.

The reflection holder may further include a chamfered portion in which a corner thereof is partially cut.

The chamfered portion may have a length in a direction, perpendicular to both the first axis and the second axis.

In a general aspect, a camera module includes a housing; a lens module disposed in the housing, and comprising at least one lens; a guide member, disposed on the housing and configured to rotate, relatively with respect to the housing about a first axis; a reflection holder, disposed on the guide member, and configured to rotate relatively with respect to the guide member about a second axis; a reflection member disposed on the reflection holder; and a driver which provides a rotational force, wherein the driver includes a plurality of driving magnets spaced apart from each other in a direction of the first axis on a first surface of the reflection holder or a second surface of the housing opposing the first surface of the reflection holder in a direction of the second axis; and a plurality of driving coils respectively disposed to face the plurality of driving magnets in the direction of the second axis, wherein the driver is spaced apart from the first axis and the second axis.

Each of the plurality of driving magnets may be spaced apart from the first axis by a same distance.

Each of the plurality of driving magnets may be spaced apart from the second axis by the same distance.

The camera module may further include a first sensing magnet including a plurality of sensing magnets disposed on different surfaces adjacent to the first surface of the reflection holder.

The first sensing magnets may be spaced apart from each other in the direction of the first axis.

The camera module may further include a second sensing magnet disposed on the first surface of the reflection holder.

The second sensing magnet may be disposed between the plurality of driving magnets.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates an exploded perspective view of an example camera module, in accordance with one or more embodiments.

FIGS. 3A and 3B illustrate perspective views of a reflection module, in accordance with one or more embodiments.

FIG. 4 illustrates an exploded perspective view of a reflection module, in accordance with one or more embodiments.

FIG. 5 illustrates a coupling relationship between a guide member and a housing.

FIG. 6 illustrates a bottom perspective view of a guide member.

FIG. 7 illustrates a coupling relationship between a reflection holder and a guide member.

FIG. 8 illustrates a bottom perspective view of the reflection holder.

FIG. 9 illustrates a plan view of a reflection module according to an example embodiment.

FIG. 10 illustrates a perspective view of a driver, a first ball member, and a second ball member according to an example embodiment of.

FIGS. 11 and 12 illustrate side views of a reflection module according to an example embodiment.

FIG. 13 illustrates a plan view of a reflection module according to another example embodiment.

FIG. 14 illustrates a perspective view of a reflection holder according to another example embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as "first," "second," and "third", or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” "connected to," "coupled to," or "joined to" another component, element, or layer, it may be directly (e.g., in contact with the other component, element, or layer) “on,” "connected to," "coupled to," or "joined to" the other component element, or layer, or there may reasonably be one or more other components elements, or layers intervening therebetween. When a component or element is described as "directly on", "directly connected to," "directly coupled to," or "directly joined to" another component element, or layer, there can be no other components, elements, or layers intervening therebetween. Likewise, expressions, for example, "between" and "immediately between" and "adjacent to" and "immediately adjacent to" may also be construed as described in the foregoing.

The terminology used herein is for describing various examples only and is not to be used to limit the disclosure. The articles "a," "an," and "the" are intended to include the plural forms as well, unless the context clearly indicates otherwise. As non-limiting examples, terms "comprise" or "comprises," "include" or "includes," and "have" or "has" specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms "comprise" or "comprises," "include" or "includes," and "have" or "has" specify the presence of stated features, numbers, operations, members, elements, and/or combinations thereof, other embodiments may exist where one or more of the stated features, numbers, operations, members, elements, and/or combinations thereof are not present.

As used herein, the term "and/or" includes any one and any combination of any two or more of the associated listed items. The phrases "at least one of A, B, and C", "at least one of A, B, or C", and the like are intended to have disjunctive meanings, and these phrases "at least one of A, B, and C", "at least one of A, B, or C", and the like also include examples where there may be one or more of each of A, B, and/or C (e.g., any combination of one or more of each of A, B, and C), unless the corresponding description and embodiment necessitates such listings (e.g., "at least one of A, B, and C") to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

The following description relates to a reflection module, and a camera module including the same. The camera module may be mounted on portable electronic devices such as, but not limited to, mobile communication terminals, smartphones, and tablet personal computers (PCs).

One or more examples may simplify a structure of the camera module, and increase the degree of freedom of shape, through a driver that participates in both dual axis rotation.

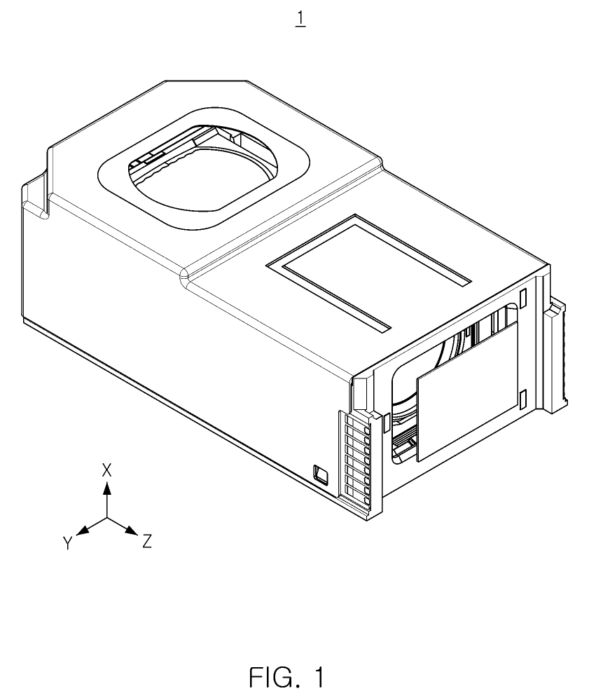

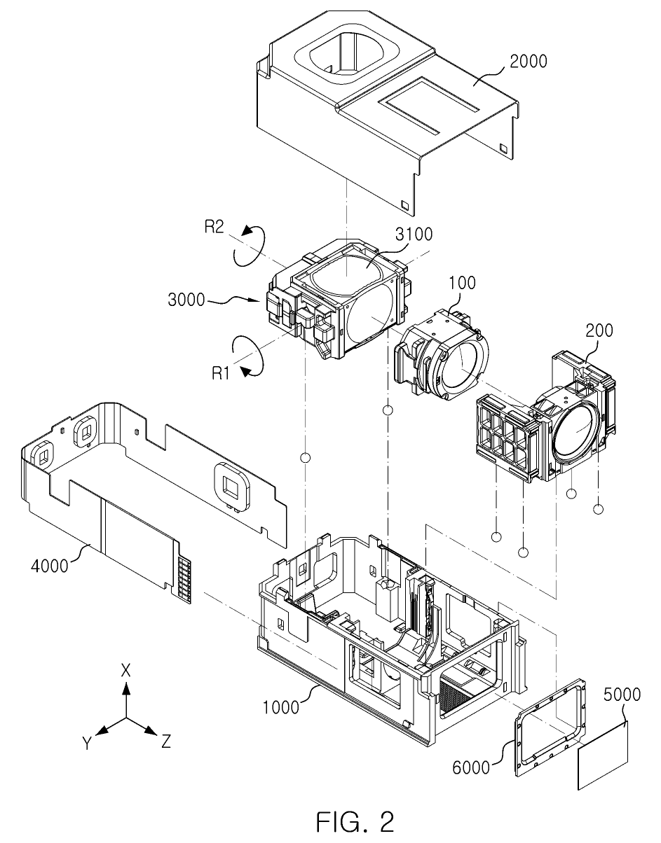

FIG. 1 illustrates a perspective view of an example camera module, in accordance with one or more embodiments, and FIG. 2 illustrates an exploded perspective view of the example camera module according to an example embodiment.

Referring to FIGS. 1 and 2, a camera module 1, according to an example embodiment, may include at least one lens module 100 or 200, a housing 1000, a reflection module 3000, and an image sensor 5000.

The camera module 1 may include the housing 1000. The housing 1000 may have an internal space that accommodates at least one of the reflection module 3000, at least one lens module 100 or 200, or the image sensor 5000.

The housing 1000 may be formed of a material having predetermined rigidity to protect components accommodated therein, and may be a box-shaped member in which an upper portion thereof is open. However, the material and shape of the housing 1000 are not limited thereto.

The camera module 1 may further include a shield can 2000 covering an upper portion of the housing 1000. The shield can 2000 may cover the open upper portion of the housing 1000 to protect components within the housing 1000 from external environments.

The shield can 2000 may include an opening through which incident light passes. The light incident through the opening may be incident on the reflection module 3000.

The camera module 1 may include at least one lens module 100 or 200. Each of the lens modules 100 and 200 may include at least one lens and a lens barrel accommodating the lens.

In an example, at least one lens module 100 or 200 may include a first lens module 100 and a second lens module 200 having the same optical axis. The light incident from an external subject to the camera module 1 may pass through the first lens module 100 and the second lens module 200, and may then be incident on the image sensor 5000. That is, the first lens module 100 may be disposed closest to the subject, and the second lens module 200 may be disposed closest to the image sensor 5000.

Light may be incident on the camera module 1 from the external subject in a first optical axis (X-axis), and the light may be reflected by the reflection module 3000 and the reflected light may be received by the image sensor 5000 in a second optical axis (Z-axis).

The first optical axis (X-axis) and the second optical axis (Z-axis) may not be parallel to each other. The first optical axis (X-axis) and the second optical axis (Z-axis) may intersect each other, and the first optical axis (X-axis) and the second optical axis (Z-axis) may be approximately perpendicular. However, an angle therebetween is not limited thereto.

The first lens module 100 and the second lens module 200 may both be disposed to have the second optical axis (Z-axis). However, the one or more examples are not limited thereto, and at least one lens module may be disposed to have the first optical axis (X-axis).

The camera module 1 may include the image sensor 5000. The image sensor 5000 may convert incident light into image information. The image sensor 5000 may be disposed so that a light collection surface thereof faces an emission surface of the second lens module 200, and may generate an electrical signal corresponding to light incident from the second lens module 200.

The image sensor 5000 may be accommodated within the housing 1000. However, the one or more examples are not limited thereto, and in an example, the image sensor 5000 may be disposed outside the housing 1000.

A filter unit 6000 may be disposed in front of the image sensor 5000 to filter at least a portion of the light incident from the lens module. The filter unit 6000 may include an optical filter that blocks light having a specific wavelength. The optical filter may be, for example, an infrared blocking filter. Additionally, the filter unit 6000 may include a light-blocking member (e.g., baffle) that blocks at least a portion of the light incident from the lens module.

At least one of the lens modules may be provided to be movable with respect to the image sensor 5000. For example, the second lens module 200 may be disposed to be movable in the second optical axis (Z-axis) with respect to the image sensor 5000. As the second lens module 200 moves in the second optical axis (Z-axis), an auto-focus operation (AF) of the camera module 1 may be performed. However, the one or more examples are not limited to the above-described embodiment, and all lens modules, including the first lens module 100, may move in the second optical axis (Z-axis), or only the first lens module 100 may move in the second optical axis (Z-axis).

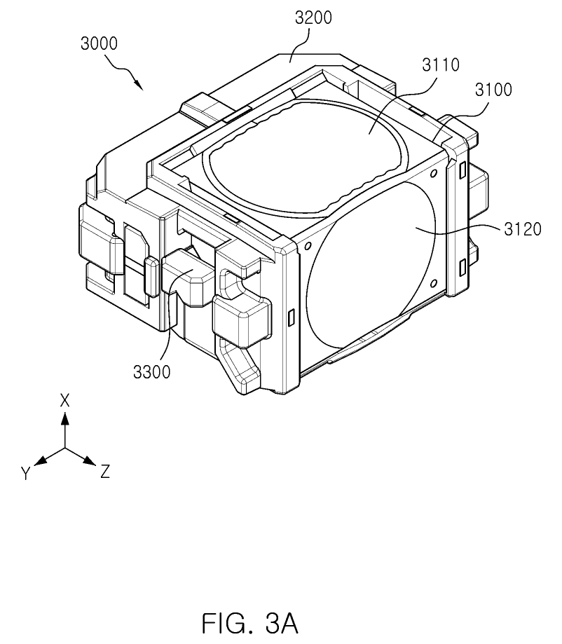

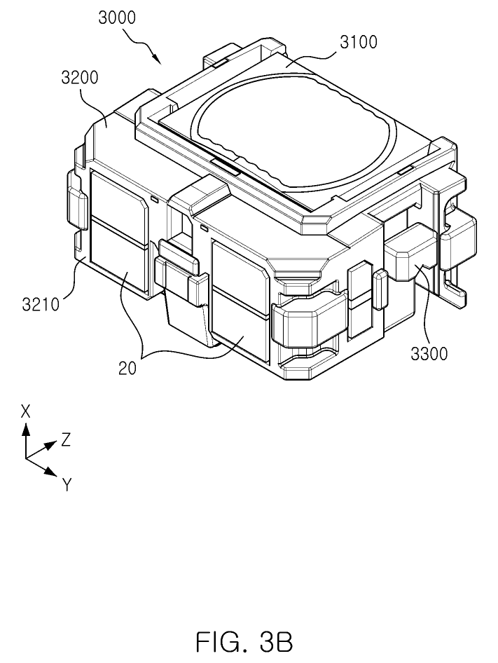

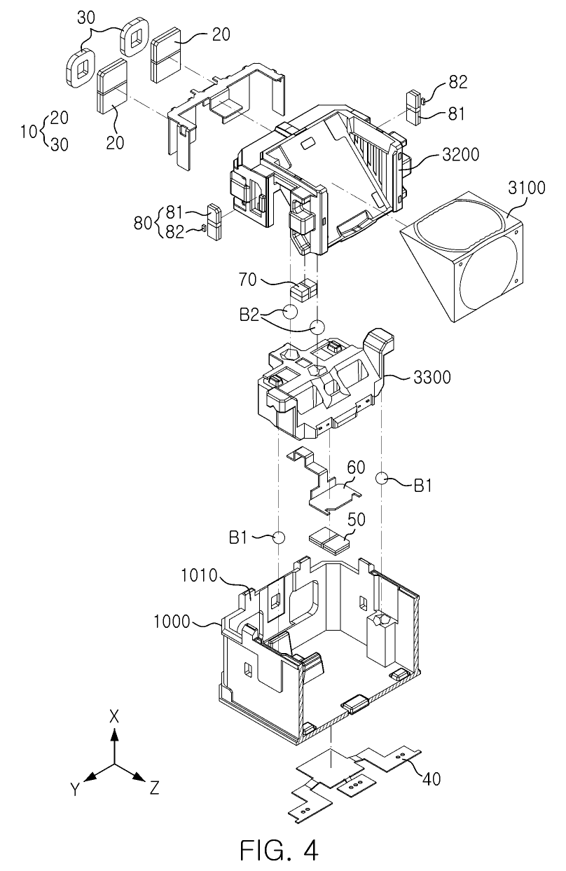

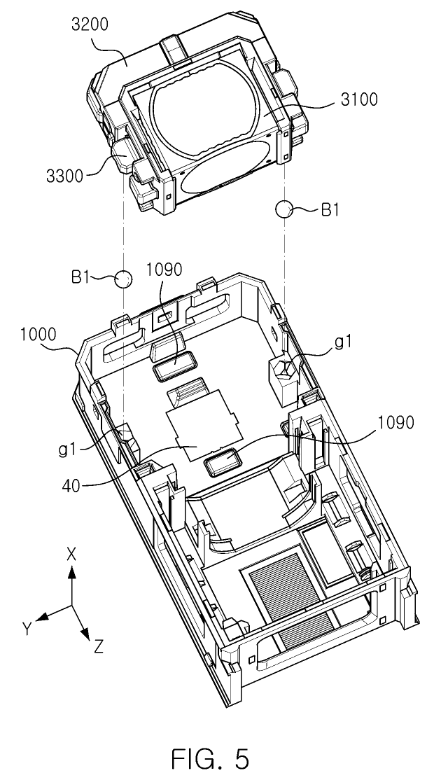

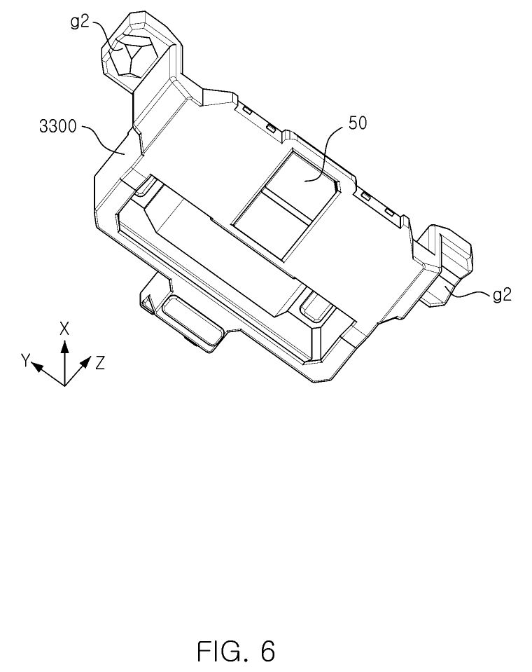

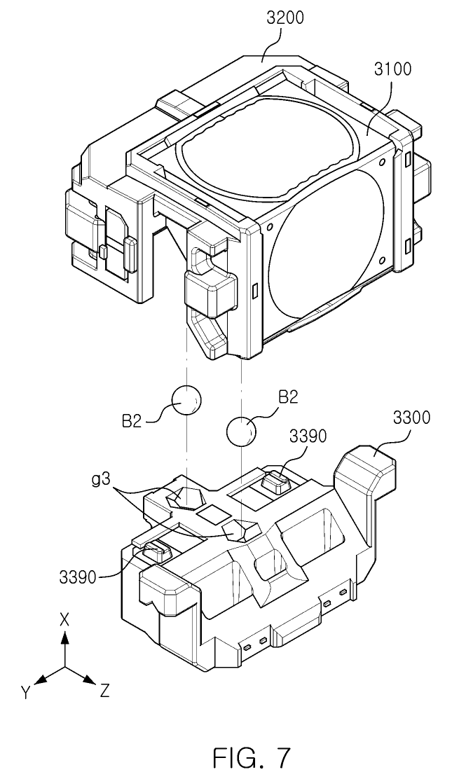

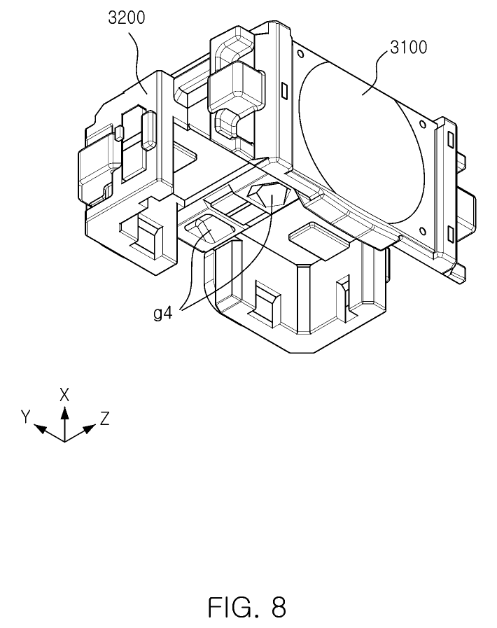

FIGS. 3A and 3B are perspective views of a reflection module according to an example embodiment, FIG. 4 is an exploded perspective view of a reflection module according to an example embodiment, FIG. 5 is a view illustrating a coupling relationship between a guide member and a housing, FIG. 6 is a bottom perspective view of the guide member, FIG. 7 is a view illustrating a coupling relationship between a reflection holder and a guide member, and FIG. 8 is a bottom perspective view of the reflection holder.

Hereinafter, with reference to FIGS. 3A-8, a reflection module 3000 according to an example embodiment will be described in detail.

The reflection module 3000 may be accommodated in the internal space of the housing 1000, and may change a path of light incident on the reflection module 3000. In an example, the reflection module 3000 may be understood as including a reflection member 3100 that changes the path of light, components that support and drive the reflection member 3100, and at least a portion of the housing 1000 accommodating the components.

The reflection module 3000 may include a reflection member 3100 that changes the light path. The reflection member 3100 may include an incident surface 3110 through which light may be incident from an external subject, a reflection surface reflecting the incident light, and an emission surface 3120 through which the reflected light may be emitted. In an example, the reflection member 3100 may be a prism or a mirror.

The reflection module 3000 may include a reflection holder 3200 on which the reflection member 3100 is mounted, and a guide member 3300 disposed in the housing 1000 and supporting the reflection holder 3200. The reflection member 3100 may be mounted on the reflection holder 3200. The reflection holder 3200 may be rotatably disposed on the guide member 3300. Additionally, the guide member 3300 may be rotatably disposed in the housing 1000.

The reflection member 3100 may be provided to be movable within the housing 1000. In an example, the reflection member 3100 may rotate around different rotation axes. As the reflection member 3100 rotates, an optical image stabilization (OIS) operation of the camera module 1 may be performed.

The guide member 3300 may be disposed to be relatively rotatable with respect to the housing 1000 around a first axis (R1). In an example, the first axis (R1) may be an axis (Y-axis), perpendicular to both the first optical axis (X-axis) and the second optical axis (Z-axis). In this example, the reflection holder 3200 may also rotate together with the guide member 3300.

The reflection holder 3200 may be disposed to be relatively rotatable with respect to the guide member 3300 about a second axis (R2). Here, the second axis (R2) may be identical to or parallel to the second optical axis (Z-axis).

In order to rotate the reflection module 3000, a driver 10 may be provided. The driver 10 may provide rotational force to rotate the guide member 3300 and the reflection holder 3200.

The driver 10 may include a plurality of driving magnets 20 and a plurality of driving coils 30. The driver 10 may allow the guide member 3300 to relatively rotate with respect to the housing 1000 about the first axis (R1). Since the reflection holder 3200 is disposed on the guide member 3300, the reflection holder 3200 may also rotate together with the guide member 3300.

A plurality of driving magnets 20 may be disposed on one surface of the reflection holder 3200 or the housing 1000. For example, as illustrated in FIG. 3B, the plurality of driving magnets 20 may be disposed on a rear surface 3210 of the reflection holder 3200. The rear surface 3210 of the reflection holder 3200 may refer to one surface of the reflection holder 3200 facing the housing 1000 in the direction of the second axis (R2). That is, the plurality of driving magnets 20 may be disposed on the same surface of the reflection holder 3200. For convenience of explanation, the following description will be based on the assumption that the plurality of driving magnets 20 are disposed on one surface of the reflection holder 3200.

Each of the plurality of drive magnets 20 may be magnetized so that one surface (e.g., a surface facing the plurality of driving coils 30) has both an N pole and an S pole. In an example embodiment, each of the surfaces of the plurality of drive magnets 20 facing the plurality of driving coils 30 may be sequentially provided with an N pole, a neutral region, and an S pole along the first optical axis (X-axis).

The plurality of driving coils 30 may be disposed to face the plurality of drive magnets 20. For example, the plurality of driving coils 30 may be disposed to face the plurality of drive magnets 20 in the direction of the second axis (R2).

The plurality of driving coils 30 may be disposed on a substrate 4000, and the substrate 4000 may be mounted on the housing 1000 so that the plurality of drive magnets 20 and the plurality of driving coils 30 face each other in the direction of the second axis (R2).

The housing 1000 may be provided with a through-hole extending along a second axis (R2), and a plurality of driving coils 30 may be disposed in the through-hole to directly face a plurality of drive magnets 20.

During shake correction, the plurality of drive magnets 20 may be movable members that are disposed on the reflection holder 3200 and rotate, and the plurality of driving coils 30 may be fixed members that are fixed to the substrate 4000 and disposed on the housing 1000.

When power is applied to the driver 10, the driver 10 may generate driving force necessary for rotation of the reflection holder 3200 and the guide member 3300 about the first axis (R1) as a rotation axis. For example, the driver 10 may generate driving force in a direction of the first optical axis (X-axis).

The driver 10 may include a plurality of driving magnets 20. The plurality of driving magnets 20 may include two magnets spaced apart from each other. The two magnets of the plurality of driving magnets 20 may be spaced apart from each other in the direction of the first axis (R1).

Both magnets of the plurality of driving magnets 20 may be disposed on one surface of the reflection holder 3200. For example, the plurality of driving magnets 20 may be disposed on the rear surface 3210 of the reflection holder 3200.

The driver 10 may include a plurality of driving coils 30. The plurality of driving coils 30 may include two coils spaced apart from each other. The two coils of the plurality of driving coils 30 may be spaced apart from each other in the direction of the first axis (R1).

Both coils of the plurality of driving coils 30 may be disposed on one surface of the housing 1000. For example, the plurality of driving coils 30 may be disposed on one surface 1010 of the housing 1000 opposing the rear surface 3210 of the reflection holder 3200 so as to face the plurality of drive magnets 20.

Due to the driving force between the plurality of drive magnets 20 and the plurality of driving coils 30, the reflection module 3000 may rotate around different axes. For example, the guide member 3300 may rotate around a first axis (R1), and the reflection holder 3200 may rotate around a second axis (R2). Details thereof will be described below.

Referring to FIG. 5, it may be seen that a first ball member B1 is disposed between the guide member 3300 and the housing 1000. The first ball member B1 may include a plurality of balls spaced apart from each other along the first axis (R1).

The first ball member B1 may be disposed between the guide member 3300 and the housing 1000 to form a rotational axis of the guide member 3300.

When a driving force is generated in the direction of the first optical axis (X-axis) by the plurality of driving magnets 20 and the plurality of driving coils 30, the guide member 3300 may rotate around the rotational axis formed by the first ball member B1. In this example, since the reflection holder 3200 is disposed on the guide member 3300, the reflection holder 3200 may also rotate around the first axis (R1) together with the guide member 3300 based on the plurality of driving magnets 20 and the plurality of driving coils 30.

A virtual line connecting a plurality of balls of the first ball member B1 along the first axis (R1) may pass through a reflection surface of the reflection member 3100.

Attractive force may be applied between the guide member 3300 and the housing 1000. For example, a first pulling magnet 50 may be disposed on one of the guide member 3300 and the housing 1000, and a first pulling yoke 40 may be disposed on the other thereof.

In an example embodiment, the first pulling magnet 50 may be disposed on a lower surface of the guide member 3300, and the first pulling yoke 40 may be disposed on a bottom surface of the housing 1000.

The first pulling magnet 50 and the first pulling yoke 40 may be disposed to face each other in the direction of the first optical axis (X-axis).

The first pulling magnet 50 and the first pulling yoke 40 may generate an attractive force between each other. In an example, the first pulling yoke 40 may be formed of a magnetic material. An attractive force may be applied between the first pulling magnet 50 and the first pulling yoke 40 in the direction of the first optical axis (X-axis).

Due to the attractive force between the first pulling magnet 50 and the first pulling yoke 40, the first ball member B1 may maintain contact with the guide member 3300 and the housing 1000, respectively.

Referring to FIGS. 5 and 6, it may be seen that a first guide groove g1 and a second guide groove g2 may be disposed on each surface of the guide member 3300 and the housing 1000 facing each other in the direction of the first optical axis (X-axis). For example, the first guide groove g1 may be disposed in the housing 1000, and the second guide groove g2 may be disposed in the guide member 3300. The first guide groove g1 and the second guide groove g2 may face each other in the direction of the first optical axis (X-axis).

The first guide groove g1 may include a plurality of grooves spaced apart in the direction of the first axis (R1). Similarly, the second guide groove g2 may also include a plurality of grooves spaced apart from each other in the direction of the first axis (R1).

The first ball member B1 may be disposed between the first guide groove g1 and the second guide groove g2 to form a rotational axis of the guide member 3300.

Each of the plurality of grooves of the first guide groove g1 may be in three-point contact with the first ball member B1.

One of the plurality of grooves of the second guide groove g2 may be in three-point contact with the first ball member B1, and another of the plurality of grooves of the second guide groove g2 may be in two-point contact with the first ball member B1. However, the one or more examples are not limited thereto, and a shape of the first guide groove g1 and a shape of the second guide groove g2 may be reversed from each other.

The housing 1000 may further include a first buffer member 1090. in an example, a plurality of first buffer members 1090 may be disposed on one surface of the housing 1000 facing the reflection module 3000 in the direction of the first optical axis (X-axis).

In an example, referring to FIG. 5, the first buffer member 1090 having elastic force may be disposed on an internal bottom surface of the housing 1000. The internal bottom surface of the housing 1000 may be a surface facing the reflection module 3000 in the direction of the first optical axis (X-axis). As another example, the first buffer member 1090 may be disposed on a lower surface of the reflection module 3000 facing the bottom surface of the housing 1000 in the direction of the first optical axis (X-axis).

One of the plurality of first buffer members 1090 may be disposed to face the guide member 3300, and another of the plurality of first buffer members 1090 may be disposed to face the reflection holder 3200.

One of the plurality of first buffer members 1090 may be spaced apart in a positive second optical axis direction (+Z-axis direction) based on the first axis (R1), and the other of the plurality of first buffer members 1090 may be spaced apart in a negative second optical axis direction (-Z-axis direction) based on the first axis (R1). That is, the plurality of first buffer members 1090 may be spaced apart from each other with the first axis (R1) interposed therebetween. In other words, the plurality of first buffer members 1090 may be spaced apart from each other with a virtual line connecting a plurality of balls of the first ball member B1 in the direction of the first axis (R1).

Accordingly, when rotating around the first axis (R1) of the reflection module 3000, a rotation range thereof may be limited, and an impact amount and noise may be reduced when the reflection module 3000 and the housing 1000 collide with each other.

Referring to FIG. 7, it may be seen that a second ball member B2 may be disposed between the guide member 3300 and the reflection holder 3200. The second ball member B2 may include a plurality of balls spaced apart from each other along the second axis (R2).

The second ball member B2 may be disposed between the guide member 3300 and the reflection holder 3200 to form a rotational axis of the reflection holder 3200.

When a driving force is generated in the direction of the first optical axis (X-axis) by the plurality of driving magnets 20 and the plurality of driving coils 30, the reflection holder 3200 may be rotated around the rotational axis formed by the second ball member B2.

A virtual line connecting the plurality of balls of the second ball member B2 along the second axis (R2) may pass through the reflection surface of the reflection member 3100.

An attractive force may be applied between the guide member 3300 and the reflection holder 3200. For example, a second pulling magnet 70 may be disposed on one of the guide member 3300 and the reflection holder, and a second pulling yoke 60 may be disposed on the other thereof.

In an example embodiment, the second pulling magnet 70 may be disposed on the reflection holder 3200, and the second pulling yoke 60 may be disposed on the guide member 3300.

The second pulling magnet 70 and the second pulling yoke 60 may be disposed to face each other in the direction of the first optical axis (X-axis).

In an example embodiment, the second pulling magnet 70 may be disposed on a lower surface of the reflection holder 3200, and the second pulling yoke 60 may be disposed on an upper surface of the guide member 3300.

The second pulling yoke 60 may be provided to extend so as to be in contact with the first pulling magnet 50. The second pulling yoke 60 may also perform an operation of focusing the magnetic flux of the first pulling magnet 50.

The second pulling magnet 70 and the second pulling yoke 60 may generate an attractive force between each other. For example, the second pulling yoke 60 may be formed of a magnetic material. Attractive force may be applied between the second pulling magnet 70 and the second pulling yoke 60 in the direction of the first optical axis (X-axis).

Due to the attractive force between the second pulling magnet 70 and the second pulling yoke 60, the second ball member B2 may maintain contact with the guide member 3300 and the reflection holder 3200, respectively.

Referring to FIGS. 7 and 8, it may be seen that a third guide groove g3 and a fourth guide groove g4 are disposed respectively on each surface of the guide member 3300 and the reflection holder 3200 facing each other in the direction of the first optical axis (X-axis). For example, the third guide groove g3 may be disposed in the guide member 3300, and the fourth guide groove g4 may be disposed in the reflection holder 3200. The third guide groove g3 and the fourth guide groove g4 may face each other in the direction of the first optical axis (X-axis).

The third guide groove g3 may include a plurality of grooves spaced apart from each other in the direction of the second axis (R2). Similarly, the fourth guide groove g4 may also include a plurality of grooves spaced apart from each other in the direction of the second axis (R2).

The second ball member B2 may be disposed between the third guide groove g3 and the fourth guide groove g4 to form a rotational axis of the reflection holder 3200.

Each of the plurality of grooves of the third guide groove g3 may be in three-point contact with the second ball member B2.

One of the plurality of grooves of the fourth guide groove g4 may be in three-point contact with the second ball member B2, and another of the plurality of grooves of the fourth guide groove g4 may be in two-point contact with the second ball member B2. However, the one or more examples are not limited thereto, and a shape of the third guide groove g3 and a shape of the fourth guide groove g4 may be reversed from each other.

The second pulling yoke 60 may be disposed between the plurality of grooves of the third guide groove g3. Additionally, the second pulling magnet 70 may be disposed between a plurality of grooves of the fourth guide groove g4.

The guide member 3300 may further include a second buffer member 3390. The plurality of second buffer members 3390 may be disposed on one surface of the guide member 3300 facing the reflection holder 3200 in the direction of the first optical axis (X-axis).

For example, referring to FIG. 7, the second buffer member 3390 having elastic force may be disposed on the upper surface of the guide member 3300. The upper surface of the guide member 3300 may be a surface facing the reflection holder 3200 in the direction of the first optical axis (X-axis). As another example, the second buffer member 3390 may be disposed on the lower surface of the reflection holder 3200 facing the upper surface of the guide member 3300 in the direction of the first optical axis (X-axis).

One of the plurality of second buffer members 3390 may be spaced apart in the positive first axis direction (+Y-axis direction) with respect to the second axis (R2), and one of the plurality of second buffer members 3390 may be spaced apart in the negative first axis direction (-Y-axis direction). That is, the plurality of second buffer members 3390 may be spaced apart from each other with the second axis (R2) interposed therebetween. In other words, the plurality of second buffer members 3390 may be spaced apart from each other with a virtual line connecting the plurality of balls of the second ball member B2 along the second axis (R2).

Accordingly, when the reflection holder 3200 rotates around the second axis (R2), a rotation range thereof may be limited, and an impact amount and noise may be reduced when the reflection holder 3200 and the guide member 3300 collide with each other.

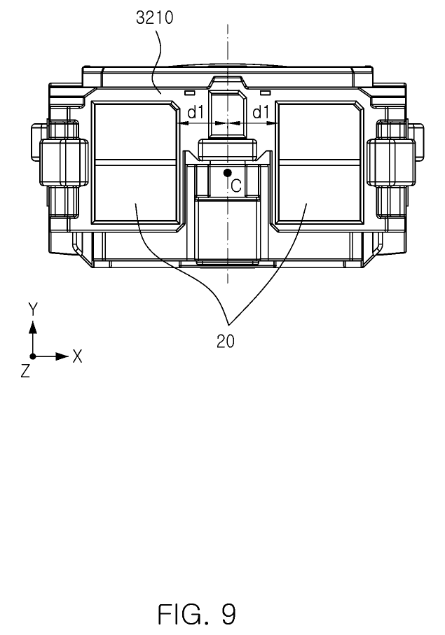

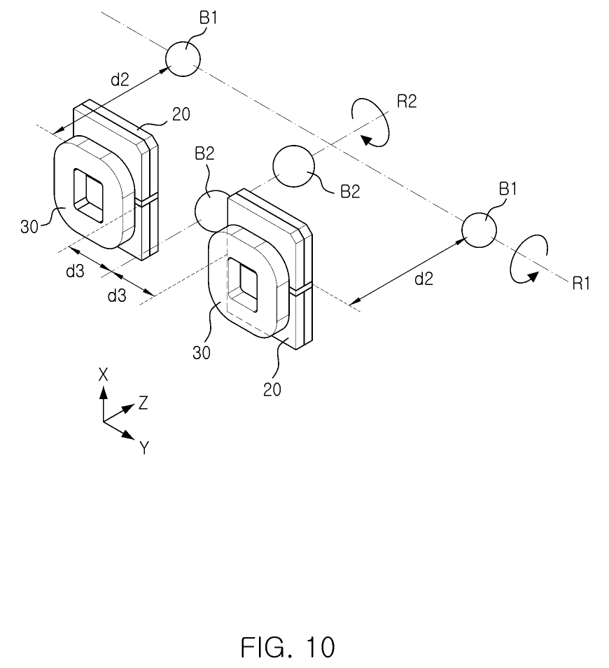

FIG. 9 is a plan view of a reflection module, in accordance with one or more embodiments, and FIG. 10 is a perspective view of a driver, a first ball member, and a second ball member, in accordance with one or more embodiments.

Several methods are adopted to perform optical image stabilization (OIS) to improve resolution in camera modules. Camera shake may be compensated for by rotating or moving the reflection module, which is typically compensated for by rotating along two different axes.

Typically, a plurality of drivers that participate in driving each rotation axis were needed to rotate a reflection module along two different axes. As the plurality of drivers were provided, a size of the reflection module naturally increased, and accordingly, a weight of the reflection module has also increased.

Accordingly, according to an example embodiment of the instant specification, the reflection module 3000 and the camera module 1 including the same provide a single driver 10 that participates in both of the rotations of the reflection module 3000 along two different axes.

As described above, the driver 10 may include a plurality of driving magnets 20 and a plurality of driving coils 30. In an example, the plurality of driving magnets 20 may include two magnets, and the plurality of driving coils 30 may include two coils. Preferably, the reflection module 3000 may rotate around two different axes by two magnets and two coils.

Hereinafter, an example embodiment in which the reflection module 3000 rotates around two different axes by the driver 10 will be described.

Referring to FIG. 9, it may be seen that a plurality of driving magnets 20 may be disposed on one surface of the reflection holder 3200. For example, the plurality of driving magnets 20 may be disposed on the rear surface 3210 of the reflection holder 3200. The rear surface 3210 of the reflection holder 3200 may refer to one surface of the reflection holder 3200 facing the housing 1000 in the direction of the second axis (R2).

Each of the plurality of driving magnets 20 may be magnetized so that one surface (e.g., a surface facing the plurality of driving coils 30) thereof has both an N pole and an S pole. In an example embodiment, a plurality of driving magnets 20 facing a plurality of driving coils 30 may be sequentially provided with an N pole, a neutral region, and an S pole on one surface thereof along the first optical axis (X-axis).

The plurality of driving coils 30 may be disposed to face the plurality of driving magnets 20. For example, the plurality of driving coils 30 may be disposed to face the plurality of driving magnets 20 in the direction of the second axis (R2).

When the guide member 3300 and the reflection holder 3200 rotate around the first axis (R1), a direction of a driving force of one pair of a driving magnet and a driving coil may be the same as a direction of a driving force of another pair of a driving magnet and a driving coil.

For example, when the direction of the driving force of one pair of a driving magnet and the driving coil is in a positive first optical axis direction (+X-axis direction), and the direction of the driving force of another pair of a driving magnet and a driving coil is also in the positive first optical axis direction (+X-axis direction), the guide member 3300 and the reflection holder 3200 may rotate together about the first axis (R1).

Furthermore, when the direction of the driving force of one pair of a driving magnet and the driving coil is in a negative first optical axis direction (-X-axis direction), and the direction of the driving force of another pair of a driving magnet and a driving coil is also in the negative first optical axis direction (-X-axis direction), the guide member 3300 and the reflection holder 3200 may rotate together about the first axis (R1).

That is, by operation of the plurality of driving magnets 20 and the plurality of driving coils 30, the guide member 3300 may relatively rotate with respect to the housing 1000 about the first axis (R1) via the first ball member B1.

When the reflection holder 3200 rotates around the second axis (R2), the direction of the driving force of one pair of a driving magnet and a driving coil may be opposite to those of another pair of a driving magnet and a driving coil.

For example, when the direction of the driving force of one pair of a driving magnet and a driving coil is in the positive first optical axis direction (+X-axis direction), and the direction of the driving force of another pair of a driving magnet and a driving coil is in the negative first optical axis direction (-X-axis direction), the reflection holder 3200 may rotate about the second axis (R2).

Additionally, when the direction of the driving force of one pair of a driving magnet and a driving coil is in the negative first optical axis direction (-X-axis direction), and the direction of the driving force of the other pair of a driving magnet and a driving coil is in the positive first optical axis direction (+X-axis direction), the reflection holder 3200 may rotate around the second axis (R2).

That is, by operation of the plurality of driving magnets 20 and the plurality of driving coils 30, the reflection holder 3200 may relatively rotate with respect to the guide member 3300 around the second axis (R2) via the second ball member B2.

Furthermore, the reflection holder 3200 may also rotate in a diagonal direction. For example, the guide member 3300 and the reflection holder 3200 may be rotated around the first axis (R1), and the reflection holder 3200 may be rotated around the second axis (R2), so that the reflection holder 3200 may be rotated in the diagonal direction.

For example, the reflection holder 3200 may be rotated in the diagonal direction by allowing the driving force to be generated only in one pair of a driving magnet and a driving coil, and preventing the driving force from being generated in the other pair of a driving magnet and a driving coil. Alternatively, the reflection holder 3200 may be rotated in the diagonal direction by making a magnitude and a direction of the driving force of one pair of a driving magnet and a driving coil different from those of another pair of a driving magnet and a driving coil.

Referring to FIG. 10, it may be seen that the driver 10 is spaced apart from the second axis (R2) in the direction of the first axis (R1) and also spaced apart from the first axis (R1) in the direction of the second axis (R2).

The driver 10 may be spaced apart from a virtual line connecting the plurality of balls of the first ball member B1 along the first axis (R1), in the direction of the second axis (R2), and the driver 10 may also be spaced apart from a virtual line connecting the plurality of balls of the second ball member B2 along the second axis (R2), in the direction of the first axis (R1). In other words, the virtual line connecting the plurality of balls of the first ball member B1 along the first axis (R1) may be spaced apart from the plurality of drive magnets 20 along the second axis (R1). Furthermore, the virtual line connecting the plurality of balls of the second ball member B2 along the second axis (R2) may be spaced apart from the plurality of drive magnets 20 along the first axis (R1).

That is, the driver 10 may be spaced apart from all rotational axes. Accordingly, the driver 10 may be disposed on the rotation axis to prevent a rotational moment from becoming zero, and the single driver 10 may participate in rotations of two different axes.

Referring to FIGS. 9 and 10, it may be seen that the plurality of drive magnets 20 may be disposed symmetrically with respect to the center C of the rear surface 3210 of the reflection holder 3200, and are each spaced from a center C of the rear surface 3210 by the same distance d1.

A virtual passing through the center C of the rear surface 3210 of the reflection holder 3200 and parallel to the second optical axis (Z-axis) may be identical to or parallel to the second axis (Z-axis).

It may be seen that each of the plurality of driving magnets 20 may be spaced apart by the same distance d2 from the first axis (R1) formed by the plurality of balls of the first ball member B1.

Furthermore, it may be seen that each of the plurality of driving magnets 20 may be spaced apart by the equal distance d3 from the second axis (R2) formed by the plurality of balls of the second ball member B2. The distance d3 from the second axis (R2) may be identical to the distance d1 from the center C of the rear surface 3210 of the reflection holder 3200. Accordingly, stable distribution of driving force may be performed.

Since the driver 10 participates in both rotations of the different axes the reflection module 3000, a structure thereof may be simplified and a weight thereof may be reduced, as compared to the typical structure.

The plurality of driving magnets 20 may be disposed on the same surface of the reflection holder 3200. A plurality of driving magnets 20 may be spaced apart from each other on the first surface 3210 of the reflection holder 3200. Alternatively, the plurality of driving magnets 20 may be spaced apart from each other on the second surface 1010 of the housing 1000 facing the first surface 3210 of the reflection holder 3200 in the direction of the second axis (R2). For convenience of explanation, the description will be based on an example in which the plurality of driving magnets 20 are disposed on the first surface 3210 of the reflection holder 3200.

The first surface 3210 of the reflection holder 3200 may be a rear surface. The rear surface of the reflection holder 3200 may be one surface of the reflection holder 3200 facing the housing 1000 in the direction of the second axis (R2).

Since the plurality of driving magnets 20 may be disposed on the first surface 3210 of the reflection holder 3200, driving magnets may not be disposed on both side surfaces (a surface adjacent to the rear surface) of the reflection holder 3200.

Accordingly, the reflection holder 3200 including side surfaces having a free space may be provided, and the degree of freedom in the shape of the reflection module 3000 may be increased.

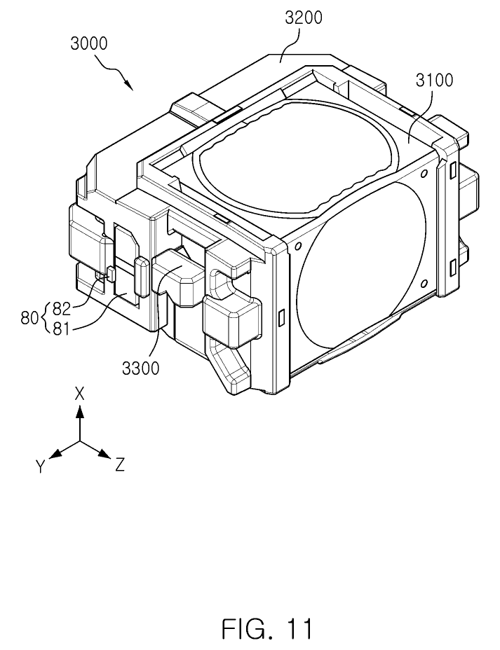

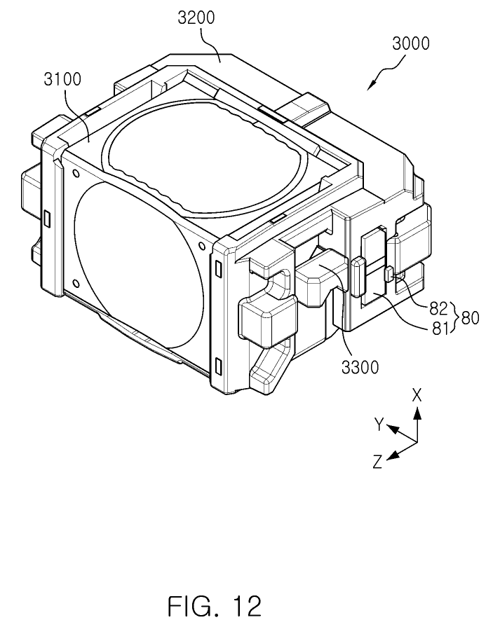

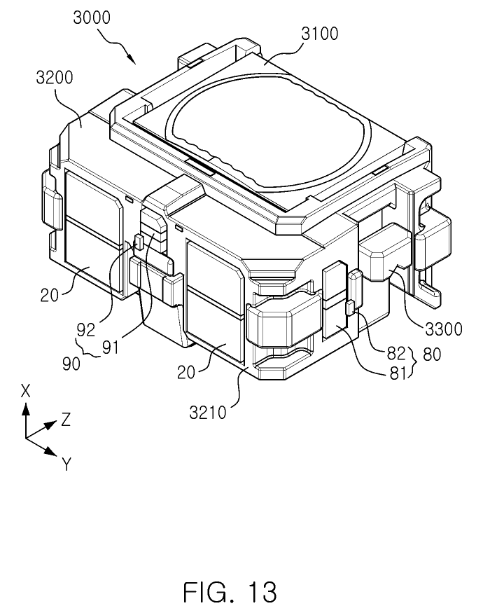

FIGS. 11 and 12 are side views of a reflection module, in accordance with one or more embodiments, and FIG. 13 is a plan view of a reflection module, in accordance with one or more embodiments.

In an example embodiment, the camera module 1 may detect positions of the guide member 3300 and the reflection holder 3200. Accordingly, the camera module 1 may include a first sensing unit 80 that detects the positions of the guide member 3300 and the reflection holder 3200. The first sensing unit 80 may include a sensing magnet and a position sensor.

The reflection module 3000, in accordance with one or more embodiments, may include a first sensing magnet 81. The first sensing magnet 81 may be disposed on the reflection holder 3200. In an example, the first sensing magnet 81 may be disposed on a side surface of the reflection holder 3200. That is, the first sensing magnet 81 may be disposed on one surface, adjacent to the first surface 3210 of the reflection holder 3200.

The first sensing magnet 81 may be provided in plural. A plurality of first sensing magnets 81 may be disposed on different surfaces, adjacent to the first surface 3210 of the reflection holder 3200.

In an example, one surface of the first sensing magnet 81 may be magnetized to have an N pole, a neutral region, and an S pole along the first optical axis (X-axis).

The reflection module 3000, in accordance with one or more embodiments, may include a first position sensor 82 that senses a position of the first sensing magnet 81. In an example, the first position sensor 82 may include a Hall sensor as a magnetic sensor. The first position sensor 82 may sense a change in a magnetic flux passing through the first position sensor 82 to sense an amount of movement of the first sensing magnet 81.

The first position sensor 82 may be disposed to face the first sensing magnet 81 in the first axis (R1) direction. The first position sensor 82 may be disposed on the substrate 4000.

When one surface of the reflection module 3000 facing the first optical axis (X-axis) and one surface of the housing 1000 are parallel to each other, the first position sensor 82 may be disposed to face the neutral region of the first sensing magnet 81. That is, the first position sensor 82 may be disposed to face a boundary region between the N pole and the S pole of the first sensing magnet 81, thereby effectively sensing a displacement of the first sensing magnet 81.

The first sensing magnet 81 may be provided in plural. Accordingly, a plurality of first position sensors 82 may also be provided, and signals sensed by each first position sensor 82 may be compared with each other to more precisely sense a change in the position of the first sensing magnet 81.

The first sensing magnet 81 may be provided in plural, and a plurality of first sensing magnets 81 may be spaced apart from each other in the direction of the first axis (R1).

A position of the reflection module 3000 rotating along two different axes may be sensed by the first sensing magnet 81 and the first position sensor 82.

When the guide member 3300 and the reflection holder 3200 rotate around the first axis (R1), a polarity area of one surface of the first sensing magnet 81 facing the first position sensor 82 changes, through which a position of the guide member 3300 may be sensed.

When the reflection holder 3200 rotates around the second axis (R2), a distance between the first sensing magnet 81 and the first position sensor 82 in the direction of the first optical axis (X-axis) changes, through which a position of the reflection holder 3200 may be sensed.

One surface of the first sensing magnet 81 facing the first position sensor 82 may sequentially have an N pole, a neutral region, and an S pole in the positive first optical axis direction (+X-axis direction). Polarity magnetization patterns of the first sensing magnets 81 provided in plural may be identical to each other.

Hereinafter, a sensing method in an example in which the polarity magnetization patterns of the plurality of first sensing magnets 81 are identical to each other will be described.

When the guide member 3300 rotates around the first axis (R1), the plurality of first position sensors 82 all move away from or move close to the same polarity. For example, due to the rotation of the guide member 3300, the plurality of first position sensors 82 may all move away from the N pole and may move close to the S pole. Additionally, the plurality of first position sensors 82 may all move away from the S pole and may move close to the N pole. Accordingly, signal values output from the plurality of first position sensors 82 may have the same form.

When the guide member 3300 rotates around the first axis (R1), the signal values output from the plurality of first position sensors 82 may be summed to accurately sense a position of the guide member 3300.

If the reflection holder 3200 rotates around the second axis (R2), when one of the plurality of first position sensors 82 moves closer to the N pole and moves away from the S pole, the other thereof may move closer to the S pole and move away from the N pole. Accordingly, signal values output from one of the plurality of first position sensors 82 and signal values output from the other thereof may have different forms.

In an example, when a signal value output from one of the plurality of first position sensors 82 is in the form of an upward straight line, a signal value output from another of the plurality of first position sensors 82 may be in the form of a downward straight line. In other words, a graph of the signal values output from the plurality of first position sensors 82 may be in the form of an X.

If the reflection holder 3200 rotates around the second axis (R2), a position of the reflection holder 3200 may be accurately sensed by performing a difference calculation on signal values output from the plurality of first position sensors 82.

In another example embodiment, one surface of one of the plurality of first sensing magnets 81 may have an S pole, a neutral region, and an N pole, sequentially, in the positive first optical axis direction (+X-axis direction). Additionally, one surface of another of the plurality of first sensing magnets 81 may sequentially have an N pole, a neutral region, and an S pole in the positive first optical axis (X-axis).

Hereinafter, a sensing method in an example in which the polarity magnetization forms of the plurality of first sensing magnets 81 are different from each other will be described.

If the guide member 3300 rotates around the first axis (R1) as the rotational axis, when one of the plurality of first position sensors 82 moves close to the N pole and moves away from the S pole, the other thereof may move close to the S pole and move away from the N pole. Accordingly, a signal value output from one of the plurality of first position sensors 82 and a signal value output from the other thereof may have different forms.

In an example, if the signal value output from one of the plurality of first position sensors 82 is in the form of an upward straight line, the signal value output from another of the plurality of first position sensors 82 may be in the form of a downward straight line. In other words, a graph of the signal values output from the plurality of first position sensors 82 may be in the form of an X.

When the guide member 3300 rotates around the first axis (R1), the position of the guide member 3300 may be accurately sensed by performing a difference calculation on the signal values output from the plurality of first position sensors 82.

When the reflection holder 3200 rotates around the second axis (R2), the plurality of first position sensors 82 all move away from or move close to the same polarity. For example, due to the rotation of the reflection holder 3200, the plurality of first position sensors 82 may all move away from the N pole and move close to the S pole. Additionally, the plurality of first position sensors 82 may all move away from the S pole and move close to the N pole. Accordingly, signal values output from the plurality of first position sensors 82 may have the same form.

When the reflection holder 3200 rotates around the second axis (R2), the signal values output from the plurality of first position sensors 82 may be summed to accurately sense the position of the reflection holder 3200.

The first sensing unit 80 may further include a controller. In an example, the controller may be a drive IC. In an example embodiment, the drive IC and the first position sensor 82 may be provided in the form of a single chip.

The first sensing unit 80 may feedback-control the signal values output from the plurality of first position sensors 82, and may thus apply power in an appropriate direction and magnitude to the first driving coil so that the reflection holder 3200 and the guide member 3300 may be disposed in a target position.

The virtual line connecting the plurality of balls of the first ball member B1 may overlap the neutral region of the first sensing magnet 81 when viewed from the second axis (R2). Furthermore, the virtual line connecting the plurality of balls of the first ball member B1 may overlap the first position sensor 82 when viewed from the second axis (R2).

A virtual line connecting the plurality of balls of the second ball member B2 may overlap the neutral region of the first sensing magnet 81 when viewed from the first axis (R1). Furthermore, the virtual line connecting the plurality of balls of the second ball member B2 may overlap the first position sensor 82 when viewed from the first axis (R1).

Referring to FIG. 13, a reflection module 3000, in accordance with one or more embodiments, may further include a second sensing magnet 91. The second sensing magnet 91 may be disposed on the reflection holder 3200. In an example, the second sensing magnet 91 may be disposed on the first surface 3210 of the reflection holder 3200. One surface of the second sensing magnet 91 may be magnetized to have an S pole, a neutral region, and an N pole along the first optical axis (X-axis).

A reflection module 3000, in accordance with one or more embodiments, may further include a second position sensor 92 that senses a position of the second sensing magnet 91. In an example, the second position sensor 92 may include a Hall sensor as a magnetic sensor. The second position sensor 92 may sense a change in the magnetic flux passing through the second position sensor 92 to sense an amount of movement of the second sensing magnet 91.

The second position sensor 92 may be disposed so as to face the second sensing magnet 91 along the second axis (R2). The second position sensor 92 may be disposed on the substrate 4000.

When one surface of the reflection module 3000 facing the second optical axis (Z-axis) and one surface of the housing 1000 are parallel to each other, the second position sensor 92 may be disposed so as to face the neutral region of the second sensing magnet 91. That is, the second position sensor 92 may be disposed so as to face a boundary region between the N pole and the S pole of the second sensing magnet 91, thereby effectively sensing the displacement of the second sensing magnet 91.

In an example, the second sensing magnet 91 may be provided in a single unit. Accordingly, the second position sensor 92 may also be provided in a single unit.

A reflection module 3000, in accordance with one or more embodiments, may further include the first sensing unit 80 including the first sensing magnet 81 and the first position sensor 82, and a second sensing unit 90 including a second sensing magnet 91 and a second position sensor 92. Accordingly, the first sensing unit 80 may sense a change in the position of the reflection holder 3200 when the reflection holder 3200 rotates around a second axis (R2), and the second sensing unit 90 may sense a change in the position of the guide member 3300 when the guide member 3300 rotates around the first axis (R1).

Each of the first sensing unit 80 and the second sensing unit 90 may sense a change in the position of the reflection module 3000 rotating around different rotational axes. Each sensing unit is configured to sense only a rotation along a specific axis, so that interference between signals may be reduced. By independently sensing the rotation along a specific axis, precision thereof may be further enhanced. Furthermore, by providing various arrangement structures for the sensing units, the degree of freedom in shape may be increased.

The second sensing magnet 91 may be disposed on the rear surface 3210 of the reflection holder 3200. The second sensing magnet 91 may be disposed between a plurality of driving magnets 20.

The neutral region of the second sensing magnet 91 may be disposed further away in the positive first optical axis direction (+X-axis direction) than the first axis (R1). In other words, the neutral region of the second sensing magnet 91 may be disposed further away in the positive first optical axis direction (+X-axis direction) than the virtual line connecting the plurality of balls of the first ball member B1.

The neutral region of the second sensing magnet 91 may be disposed further away in the positive first optical axis direction (+X-axis direction) than the second axis (R2). In other words, the neutral region of the second sensing magnet 91 may be disposed further away in the positive first optical axis direction (+X-axis direction) than the virtual line connecting the plurality of balls of the second ball member B2.

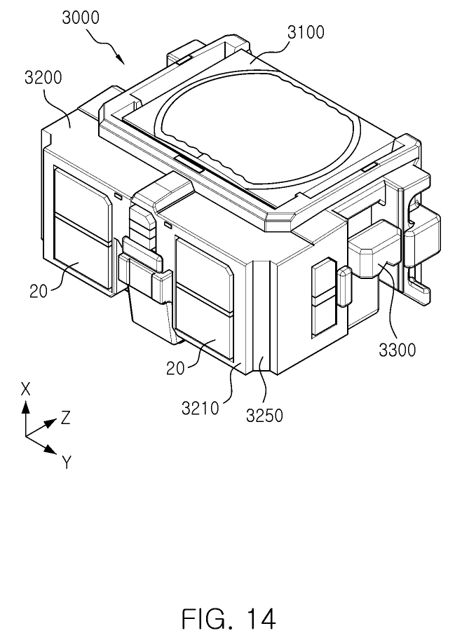

FIG. 14 is a perspective view of a reflection holder according to another example embodiment.

The reflection holder 3200 according to another example embodiment may further include a chamfered portion 3250 in which a corner thereof is partially cut. The corner of the reflection holder 3200 may refer to a portion in which the rear surface 3210 and the side surface of the reflection holder 3200 meet. The chamfered portion 3250 may be provided in plural.

The chamfered portion 3250 may have a length in the direction of the first optical axis (X-axis). That is, the chamfered portion 3250 may have a length in a direction, perpendicular to both the first axis (R1) and the second axis (R2).

As the chamfered portion 3250 is provided, the length of the reflection holder 3200 in the direction of the first axis (R1) may be reduced, and the length in the direction of the second axis (R2) may also be reduced. That is, an overall size of the reflection module 3000 may be reduced.

Furthermore, As the chamfered portion 3250 is provided, interference between components, such as collisions due to the rotation of the reflection module 3000, may be reduced.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A reflection module, comprising:
a housing;
a guide member, disposed on the housing and configured to rotate, relatively with respect to the housing about a first axis;
a reflection holder, disposed on the guide member, and configured to rotate relatively with respect to the guide member about a second axis;
a reflection member disposed on the reflection holder; and
a driver which provides a rotational force to rotate the guide member and the reflection holder,
wherein the driver comprises:
a plurality of driving magnets spaced apart from each other in a direction of the first axis; and
a plurality of driving coils disposed to face each of the plurality of driving magnets in a direction of the second axis,
wherein the plurality of driving magnets are disposed on one surface of the reflection holder or the housing, and
wherein the driver is spaced apart from a center of the one surface.

2. The reflection module according to claim 1, wherein the driver is spaced apart from the second axis in the direction of the first axis, and
wherein the driver is spaced apart from the first axis in the direction of the second axis.

3. The reflection module according to claim 2, wherein each of the plurality of driving magnets are spaced apart from the first axis by a same distance.

4. The reflection module according to claim 1, wherein the plurality of driving magnets are disposed symmetrically with respect to the center of the one surface.

5. The reflection module according to claim 4, wherein each of the plurality of driving magnets are spaced apart from the center of the one surface by a same distance.

6. The reflection module according to claim 1, wherein a first ball member comprising a plurality of balls is disposed between the guide member and the housing, and
wherein the plurality of balls of the first ball member are spaced apart from each other in the direction of the first axis.

7. The reflection module according to claim 6, wherein a second ball member comprising a plurality of balls is disposed between the guide member and the reflection holder, and
wherein the plurality of balls of the second ball member are spaced apart from each other in the direction of the second axis.

8. The reflection module according to claim 7, wherein a virtual line connecting the plurality of balls of the first ball member in the direction of the first axis is spaced apart from the plurality of driving magnets in the direction of the second axis, and
wherein a virtual line connecting the plurality of balls of the second ball member in the direction of the second axis is spaced apart from the plurality of driving magnets in the direction of the first axis.

9. The reflection module according to claim 1, wherein a plurality of first sensing magnets spaced apart from each other in the direction of the first axis are further comprised in the reflection holder.

10. The reflection module according to claim 9, further comprising:
a second sensing magnet disposed between the plurality of driving magnets.

11. The reflection module according to claim 1, wherein the reflection holder further comprises a chamfered portion in which a corner thereof is partially cut.

12. The reflection module according to claim 11, wherein the chamfered portion has a length in a direction, perpendicular to both the first axis and the second axis.

13. A camera module, comprising:
a housing;
a lens module disposed in the housing, and comprising at least one lens;
a guide member, disposed in the housing and configured to rotate, relatively with respect to the housing about a first axis;
a reflection holder, disposed on the guide member, and configured to rotate relatively with respect to the guide member about a second axis;
a reflection member disposed on the reflection holder; and
a driver which provides a rotational force,
wherein the driver comprises:
a plurality of driving magnets spaced apart from each other in a direction of the first axis on a first surface of the reflection holder or a second surface of the housing opposing the first surface of the reflection holder in a direction of the second axis; and
a plurality of driving coils respectively disposed to face the plurality of driving magnets in the direction of the second axis,
wherein the driver is spaced apart from the first axis and the second axis.

14. The camera module according to claim 13, wherein each of the plurality of driving magnets is spaced apart from the first axis by a same distance.

15. The camera module according to claim 14, wherein each of the plurality of driving magnets is spaced apart from the second axis by the same distance.

16. The camera module according to claim 13, further comprising:
a first sensing magnet comprising a plurality of sensing magnets disposed on different surfaces adjacent to the first surface of the reflection holder.

17. The camera module according to claim 16, wherein the first sensing magnets are spaced apart from each other in the direction of the first axis.

18. The camera module according to claim 13, further comprising:
a second sensing magnet disposed on the first surface of the reflection holder.

19. The camera module according to claim 18, wherein the second sensing magnet is disposed between the plurality of driving magnets.
